(19) United States
(12) Patent Application Publication
(10) Pub. No.: US 2026/0161220 A1
(43) Pub. Date: Jun. 11, 2026

(54) INFORMATION PROCESSING DEVICE, INFORMATION PROCESSING METHOD, AND STORAGE MEDIUM

(71) Applicant: SONY GROUP CORPORATION, TOKYO (JP)

(72) Inventors: TAKURO NODA, TOKYO (JP); MIYU IWAFUNE, TOKYO (JP); KENJI MORITA, TOKYO (JP); AKIRA UEHARA, TOKYO (JP)

(21) Appl. No.: 18/704,064

(22) PCT Filed: Sep. 20, 2022
(86) PCT No.: PCT/JP2022/034886

§ 371 Date: Apr. 24, 2024

(30) Foreign Application Priority Data
Nov. 2, 2021 (JP) 2021-179266

(51) Int. Cl. G06F 3/01; G06F 3/16

(52) U.S. Cl. CPC G06F 3/013; G06F 3/167

(57) ABSTRACT

To perform smoother user communication. An information processing device including: an acquisition unit configured to acquire line-of-sight information indicating a direction of a line-of-sight of a user; an estimation unit configured to estimate an object visually recognized by the user on the basis of the line-of-sight information; and a control unit configured to control a motion of a target on the basis of the object visually recognized by the user.

### TECHNICAL FIELD

The present disclosure relates to an information processing device, an information processing method, and a storage medium.

### BACKGROUND ART

In recent years, a technology has been developed in which a target such as an avatar or a robot communicates with a user. For example, Patent Document 1 discloses a technology for enhancing the sense of reality of a more natural expression of an avatar by independently moving the avatar's eyes and head.

### CITATION LIST

### Patent Document

Patent Document 1: Japanese Patent Application Laid-Open No. 2004-141421

### SUMMARY OF THE INVENTION

### Problems to Be Solved by the Invention

However, in the technology disclosed in Patent Document 1, since nonverbal behavior such as the direction of the line-of-sight of the user is not used, it is difficult to incorporate prior information before communication into the avatar's motion.

Therefore, the present disclosure proposes an information processing device, an information processing method, and a storage medium, which are new and improved and in which the user can perform smoother communication.

### Solutions to Problems

According to the present disclosure, there is provided an information processing device including: an acquisition unit configured to acquire line-of-sight information indicating a direction of a line-of-sight of a user; an estimation unit configured to estimate an object visually recognized by the user on the basis of the line-of-sight information; and a control unit configured to control a motion of a target on the basis of the object visually recognized by the user.

Furthermore, according to the present disclosure, there is provided an information processing method executed by a computer, the method including: acquiring line-of-sight information indicating a direction of a line-of-sight of a user; estimating an object visually recognized by the user on the basis of the line-of-sight information; and controlling a motion of a target on the basis of the object visually recognized by the user.

Furthermore, according to the present disclosure, there is provided a non-transitory computer-readable storage medium storing a program for causing a computer to execute: an acquisition function of acquiring line-of-sight information indicating a direction of a line-of-sight of a user; an estimation function of estimating an object visually recognized by the user on the basis of the line-of-sight information; and a control function of controlling a motion of a target on the basis of the object visually recognized by the user.

### BRIEF DESCRIPTION OF DRAWINGS

FIG. 1 is an explanatory diagram for describing an overview of an information processing system according to the present disclosure.

FIG. 2 is an explanatory diagram for describing a functional configuration example of an information processing device 10 according to the present disclosure.

FIG. 3 is an explanatory diagram for describing an example of motion control for an avatar A according to a first embodiment.

FIG. 4 is an explanatory diagram for describing an example of motion control for an avatar A according to a second embodiment.

FIG. 5 is an explanatory diagram for describing an example of motion control for an avatar A according to the second embodiment.

FIG. 6 is an explanatory diagram for describing an example of motion control for an avatar A according to the second embodiment.

FIG. 7 is an explanatory diagram for describing another example of motion control for an avatar A according to the second embodiment.

FIG. 8 is an explanatory diagram for describing a specific example of motion control for an avatar A according to a third embodiment.

FIG. 9 is an explanatory diagram for describing a specific example of motion control for an avatar A according to a fourth embodiment.

FIG. 10 is an explanatory diagram for describing an example of an entire flow of operation processing of an information processing device 10 according to the present disclosure.

FIG. 11 is an explanatory diagram for describing operation processing of directing a line-of-sight according to the present disclosure.

FIG. 12 is an explanatory diagram for describing an example of operation processing when a plurality of user is present.

FIG. 13 is an explanatory diagram for describing an example of operation processing when a plurality of user is present.

FIG. 14 is a block diagram illustrating a hardware configuration of an information processing device 10 according to the present disclosure.

### MODE FOR CARRYING OUT THE INVENTION

A preferred embodiment of the present disclosure is hereinafter described in detail with reference to the accompanying drawings. Note that, in the present description and the drawings, components having substantially the same functional configuration are denoted by the same reference sign, and redundant descriptions are omitted.

Furthermore, the “mode for carrying out the invention” will be described according to the order of items to be described below.
1. Overview of information processing system
1.1. Overview
1.2. Functional configuration example of information processing device 10
2. Details
2.1. Motion control for avatar
2.2. First embodiment
2.3. Second embodiment
2.4. Third embodiment
2.5. Fourth embodiment
3. Example of operation processing
3.1. Entire flow
3.2. Flow according to operation processing of directing line-of-sight
3.3. Flow according to operation processing when a plurality of users is present
4. Hardware configuration example
5. Supplement notes

### 1. Overview of Information Processing System

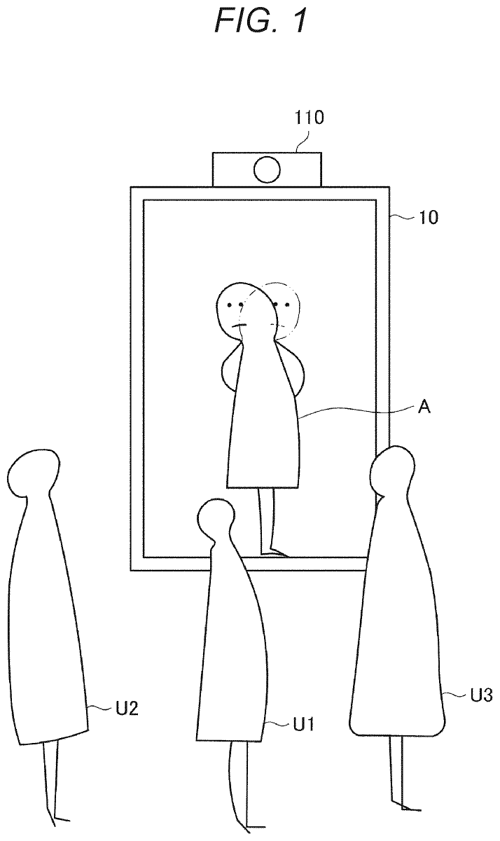

An embodiment of the present disclosure relates to an information processing system capable of performing smoother communication with a user. Hereinafter, an overview of the information processing system according to the present disclosure will be described with reference to FIG. 1.

### 1.1. Overview

FIG. 1 is an explanatory diagram for describing an overview of the information processing system according to the present disclosure. The information processing system according to the present disclosure includes an information processing device 10 as illustrated in FIG. 1. Furthermore, as illustrated in FIG. 1, the information processing device 10 according to the present disclosure includes a camera 110.

The camera 110 according to the present disclosure is a device that captures an image of a user by imaging an installed environment. For example, the camera 110 acquires an image including a user U1, a user U2, and a user U3 which are illustrated in FIG. 1. Note that the camera 110 according to the present disclosure may be, for example, an RGB camera, a time of flight (ToF), a stereo camera, and an infrared camera.

Furthermore, the information processing device 10 according to the present disclosure may include light detection and ranging (LiDAR).

Then, the information processing device 10 according to the present disclosure acquires line-of-sight information indicating a direction of the line-of-sight of the user from the image obtained by the camera 110.

Furthermore, the information processing device 10 estimates an object visually recognized by the user on the basis of the acquired line-of-sight information. Then, the information processing device 10 controls the motion of the target on the basis of the object visually recognized by the user.

For example, the information processing device 10 according to the present disclosure controls the motion of an avatar A, which is an example of the target, on the basis of the object visually recognized by the user U1, the user U2, and the user U3. Here, the object may be a virtual object or a real object. Furthermore, the virtual object may be the avatar A.

For example, in a case where the user U1 does not visually recognize any object and the user U2 and the user U3 visually recognize the avatar A, the information processing device 10 according to the present disclosure may control the operation of alternately directing the line-of-sight of the avatar A to the user U2 and the user U3 as illustrated in FIG. 1. Note that the image of the avatar may be displayed by a two-dimensional display as illustrated in FIG. 1, or may be displayed using a device such as a transparent display, a three-dimensional display, or an extended reality (XR) device.

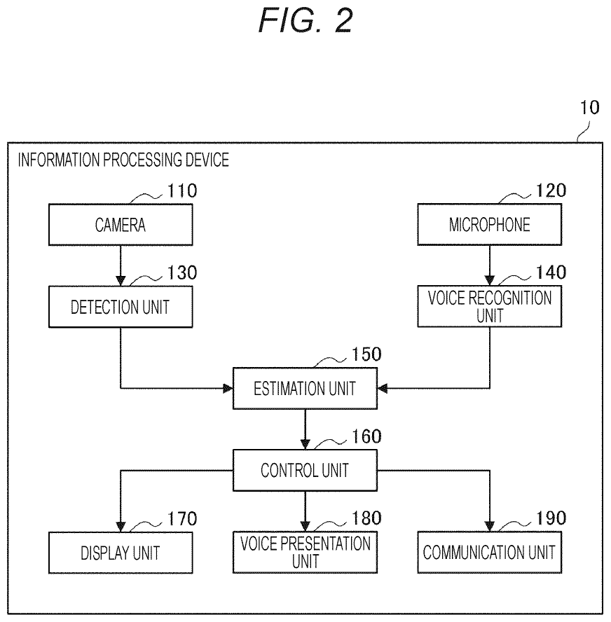

Next, a functional configuration example of the information processing device 10 according to the present disclosure will be described with reference to FIG. 2.

### 1.2. Functional Configuration Example of Information Processing Device 10

FIG. 2 is an explanatory diagram for describing a functional configuration example of the information processing device 10 according to the present disclosure. As illustrated in FIG. 2, the information processing device 10 according to the present disclosure includes the camera 110, a microphone 120, a detection unit 130, a voice recognition unit 140, an estimation unit 150, a control unit 160, a display unit 170, a voice presentation unit 180, and a communication unit 190. Note that the functional example of the camera 110 has been described above, and thus the following description will be omitted.

### Microphone 120

The microphone 120 according to the present disclosure is a device that acquires various sounds such as an environmental sound and a voice uttered by the user.

### Detection Unit 130

The detection unit 130 according to the present disclosure detects the user from the image acquired by the camera 110.

Furthermore, the detection unit 130 according to the present disclosure is an example of an acquisition unit, and the detection unit 130 detects line-of-sight information indicating a direction of the line-of-sight of the user from the image obtained by the camera 110.

Note that a method for detecting line-of-sight information according to the present disclosure is not limited to a detection method based on an image. For example, the detection unit 130 may detect the line-of-sight information by using a pupil-corneal reflex method.

Furthermore, the detection unit 130 may detect motion information indicating the motion of the user. Furthermore, the detection unit 130 may detect facial information indicating the direction of a user's face.

### Voice Recognition Unit 140

The voice recognition unit 140 according to the present disclosure is an example of an acquisition unit, and the voice recognition unit 140 recognizes voice information indicating words uttered by the user. For example, the voice recognition unit 140 may recognize words uttered by the user from the voice acquired by the microphone 120. Furthermore, the voice recognition unit 140 according to the present disclosure may recognize various types of information such as the voice quality and the voice volume of the user included in the voice.

### Estimation Unit 150

The estimation unit 150 according to the present disclosure estimates an object visually recognized by the user on the basis of the line-of-sight information detected by the detection unit 130.

Furthermore, the estimation unit 150 may estimate a group indicating a group moving in the same or similar direction or at the same or similar speed on the basis of the motion information detected by the detection unit 130. Details of the group will be described later.

### Control Unit 160

The control unit 160 according to the present disclosure controls the motion of the target on the basis of the object visually recognized by the user and estimated by the estimation unit 150. For example, when the object visually recognized by the user and estimated by the estimation unit is an avatar, the control unit 160 controls the operation of directing the line-of-sight of the avatar to the user.

Furthermore, the control unit 160 may control a predetermined motion of the avatar when the eye contact with the user to which the line-of-sight of the avatar is directed is established. Details regarding the determination as to whether or not the eye contact is established will be described later.

Furthermore, the control unit 160 may control the motion of the avatar on the basis of the voice information recognized by the voice recognition unit 140. For example, the control unit 160 may control the operation of causing the user to interact with the avatar on the basis of voice information indicating words uttered by a certain user.

### Display Unit 170

The display unit 170 according to the present disclosure presents various kinds of information regarding the image under the control of the control unit 160. For example, the display unit 170 displays the avatar of which the motion is controlled by the control unit 160.

Furthermore, the display unit 170 includes, for example, a display. The type of display is not limited. For example, the display included in the display unit 170 may be a liquid crystal display (LCD), an organic electro-luminescence (EL) display, a plasma display panel (PDP), or the like.

### Voice Presentation Unit 180

The voice presentation unit 180 according to the present disclosure presents various kinds of information regarding the voice under the control of the control unit 160. For example, the voice presentation unit 180 outputs a voice uttered by the avatar controlled by the control unit 160. The voice presentation unit 180 includes, for example, a speaker.

### Communication Unit 190

The communication unit 190 according to the present disclosure performs various communication with a terminal used by the user. For example, the line-of-sight information of the user is transmitted to a terminal used by another user. Furthermore, the communication unit 190 may transmit information regarding the motion of the avatar controlled by the control unit 160 to a terminal used by another user.

The functional configuration example of the information processing device 10 according to the present disclosure has been described above. Next, the embodiment according to the present disclosure will be described in detail.

### 2. Details

In recent years, as an interface between a user and a machine, a user interface (UI) in which communication with an avatar resembling a person or an animal is performed has been widespread instead of an operation UI using a UI button.

In such communication between the user and the avatar, nonverbal interactions such as eye contact and joint attention may be an important factor for transferring the state of the system.

Therefore, it is desirable to dynamically control the motion of the avatar according to the object visually recognized by the user.

Then, the information processing device 10 according to the present disclosure acquires line-of-sight information indicating a direction of the line-of-sight of the user, and estimates an object visually recognized by the user on the basis of the line-of-sight information. Moreover, the information processing device 10 according to the present disclosure controls the motion of the avatar on the basis of the object visually recognized by the user.

For example, the control unit 160 according to the present disclosure controls the operation of directing the line-of-sight of the avatar to the user on the basis of the object visually recognized by the user.

Moreover, after the line-of-sight of the avatar is directed to the user, the control unit 160 may control a predetermined motion of the avatar when the eye contact between the user and the avatar is established. Here, the predetermined motion may include, for example, a motion of smiling toward the user or a motion of interacting with the user.

The establishment of the eye contact according to the present disclosure may include, for example, that the line-of-sight of the avatar and the line-of-sight of the user to which the line-of-sight of the avatar is directed have been maintained for a predetermined time or more.

Furthermore, the establishment of the eye contact may include acquisition of specific motion information of the user to which the line-of-sight of the avatar is directed. The specific motion information includes, for example, motion information including a motion of waving a hand and motion information including a motion of smiling. Furthermore, the specific motion information may include motion information including a motion of the user approaching the avatar.

As described above, the information processing device 10 according to the present disclosure controls the predetermined motion of the avatar according to whether or not the eye contact between the user and the avatar is established, and thus the smoother communication between the user and the avatar can be made.

Furthermore, in the operation of directing the line-of-sight of the avatar, the control unit 160 may perform control to direct the line-of-sight of the avatar to the user by moving the direction of the avatar's eyes, or may perform control to direct the line-of-sight of the avatar to the user by moving the direction of the head in addition to the direction of the avatar's eyes. Hereinafter, a specific example of controlling the motion of the avatar will be described.

### 2.1. Motion Control of Avatar

As the avatar, animation may be set depending on a situation. In this case, the posture of the avatar dynamically changes on the basis of the set animation. Therefore, the control unit 160 according to the present disclosure may control the direction of the avatar's eyes and the direction of the avatar's head while continuing the motion of the set animation.

For example, the control unit 160 may superimpose an additional motion on the motion of the animation set as the avatar by applying inverse kinematics (IK). For example, the control unit 160 can control the direction of the head including the neck, the shoulder, and the like of the avatar by applying IK to the direction of the head, and can control the motion of the avatar more like a human.

Furthermore, the control unit 160 may control the direction of the avatar's head on the basis of a direction in which the avatar's head faces and a direction in which the user is present. For example, when the angle between the direction in which the avatar's head faces and the direction in which the user is present is a predetermined value or more, the control unit 160 may perform control to move the avatar's head toward the direction in which the user is present.

Furthermore, the control unit 160 may perform control to move the direction of the user's eyes prior to the control to move the direction of the avatar's head. For example, when the angle between the direction in which the avatar's head faces and the direction in which the user is present is a predetermined value or more, the control unit 160 may perform control to direct the line-of-sight of the avatar to the user and further move the avatar's head toward the direction in which the user is present.

Furthermore, when the angle between the direction in which the avatar's head faces and the direction in which the user is present is less than a predetermined value, the control unit 160 may perform control operation of directing only the line-of-sight of the avatar to the user.

The predetermined value includes a movable range of the direction of the line-of-sight of the avatar and a movable range of the direction of the avatar's head. The predetermined value may be determined on the basis of, for example, characteristics or characterization of the avatar.

For example, the movable range of the direction of the avatar's head may be limited to “within ±60°” in a horizontal direction and “within ±30°” in a vertical direction with respect to the direction of the avatar's body.

Furthermore, an angle of viewing only with the avatar's eyes may be limited to, for example, “within ±15°” in the horizontal direction and “within ±15°” in the vertical direction with respect to the direction of the avatar's head. In this manner, in a case where the user is within the angle of viewing only with the eyes, the control unit 160 sets a head motion interpolation operation mode to OFF. In this case, the control unit 160 controls the operation of directing the line-of-sight to the user only by moving the avatar's eyes. Furthermore, in the control of moving the direction of the head in addition to the eyes, the control unit 160 sets the head motion interpolation operation mode to ON.

Moreover, reference values of the direction of the line-of-sight of the avatar and the direction of the avatar's head may be determined according to the characteristics or characterization of the avatar.

For example, in the case of an avatar in which the reference value of the direction of the line-of-sight in the vertical direction is set to “−15°”, the limitation of the angle of viewing only with the avatar's eyes in the vertical direction may be set to “within ±15°” with respect to “−15°” which is the reference value. That is, the lower limit of the angle of viewing only with the avatar eyes is “−30°”, and the upper limit thereof is “0°”.

More specifically, for example, in the case of an avatar having upturned eyes as a characteristic, the reference value of the direction of the line-of-sight in the vertical direction may be set to “+5°”.

In this manner, in a case of controlling the operation of directing the line-of-sight of the avatar to the user in a direction exceeding the angle of viewing only with the avatar's eyes, the control unit 160 may perform control to move the direction in which the head faces to the direction in which the user is present, in addition to the operation of directing the line-of-sight of the avatar to the user.

Furthermore, the control unit 160 may perform control to move the avatar's head toward the direction in which the user is present at a speed corresponding to the magnitude of the motion of the user or the magnitude of the angle between the direction in which the avatar's head is facing and the direction in which the user is present.

A specific example of the motion control for the avatar according to the present disclosure has been described above. Next, an embodiment using the above-described motion control for the avatar will be sequentially described. Note that any one of a first embodiment, a second embodiment, a third embodiment, and a fourth embodiment according to the present disclosure may be executed, or a combination of these embodiments may be executed.

### 2.2. First Embodiment

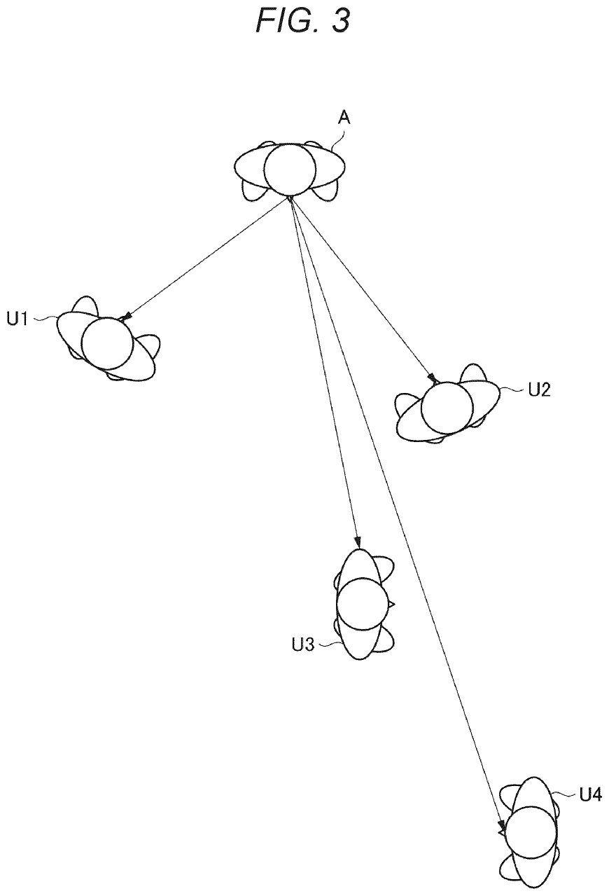

FIG. 3 is an explanatory diagram for describing an example of the motion control for an avatar A according to a first embodiment. FIG. 3 illustrates an example of a virtual space in which the avatar A and the avatars corresponding to a plurality of users are disposed. In the following description, an avatar operated by the user may be simply referred to as a user for convenience of description. For example, a user U1 accurately indicates an avatar operated by the user U1.

Furthermore, an example in which the avatar A is a non-player character (NPC) will be mainly described, but the avatar A may be a player character (PC).

For example, in a case where the user U1 visually recognizes the avatar A, the control unit 160 may control the operation of directing the line-of-sight of the avatar A to the user U1.

Furthermore, in a case where a plurality of users visually recognizes the avatar A, the control unit 160 may control the operation of preferentially directing the line-of-sight of the avatar A to the user with which eye contact is likely to be established.

For example, in a case where the user U1 and the user U2 visually recognize the avatar A, the control unit 160 may control the operation of directing the line-of-sight of the avatar A to, for example, the user U1 who is closer to the avatar A in the user U1 and the user U2. As described above, the determination for the user with who the eye contact is likely to be established may include the closeness of the distance to the avatar and the moving speed of the user.

Then, when the eye contact is not established between the user U1 and the avatar A, the control unit 160 may control the operation of directing the line-of-sight of the avatar A to the user U2 who is another user visually recognizing the avatar A.

Furthermore, in a case where none of the users U1 to U4 visually recognizes the avatar A, the control unit 160 may control the operation of sequentially directing the line-of-sight of the avatar A to the users U1 to U4 as illustrated in FIG. 3.

Furthermore, the control unit 160 may control the operation of directing the line-of-sight of the avatar A to the user who is expected to have the avatar A in a field of view. For example, the control unit 160 may control the operation of sequentially directing the line-of-sight of the avatar A to the user having the avatar A in a range “within ±94°” in the horizontal direction with respect to the face.

For example, in the example illustrated in FIG. 3, since the avatar A is not present in the range “within ±94°” of the field of view of the user U3, the control unit 160 may control the operation of sequentially directing the line-of-sight of the avatar A to the user U1, the user U2, and the user U4 excluding the user U3. Note that “within ±94°” is an example of the range of the field of view of a person, and the range with respect to the user's face is not limited to such an example. For example, other ranges may be applied instead of “within ±94°”, a range may be specified in the vertical direction for the user's face, or a range may be specified in each of the horizontal direction and the vertical direction.

Furthermore, the control unit 160 may control the operation of directing the line-of-sight of the avatar A to the user of which a distance to the avatar A is within a certain value. For example, in a case where the user U1 and the user U2 are present within a certain distance, the control unit 160 may control the operation of sequentially directing the line-of-sight of the avatar A to the user U1 and the user U2.

Then, for example, in a case where the user U1 notices the line-of-sight of the avatar A and the user U1 also visually recognizes the avatar A, the control unit 160 may perform control to direct the line-of-sight of the avatar A only to the user U1 and attempt to make eye contact with the user U1.

Then, in a case where the eye contact between the user U1 and the avatar A is established, the control unit 160 may control a predetermined motion of the avatar A. For example, the control unit 160 may control the motion of the avatar A smiling to the user U1, or may control the motion of the avatar A speaking to the user U1.

In this manner, the control unit 160 may control the operation of sequentially directing the line-of-sight of the avatar A until the eye contact with any user is established.

In the first embodiment described above, the information processing device 10 according to the present disclosure can increase the possibility of establishing the eye contact between the avatar and the user by directing the line-of-sight of the avatar to a plurality of users even in a case where there is no user visually recognizing the avatar.

### 2.3. Second Embodiment

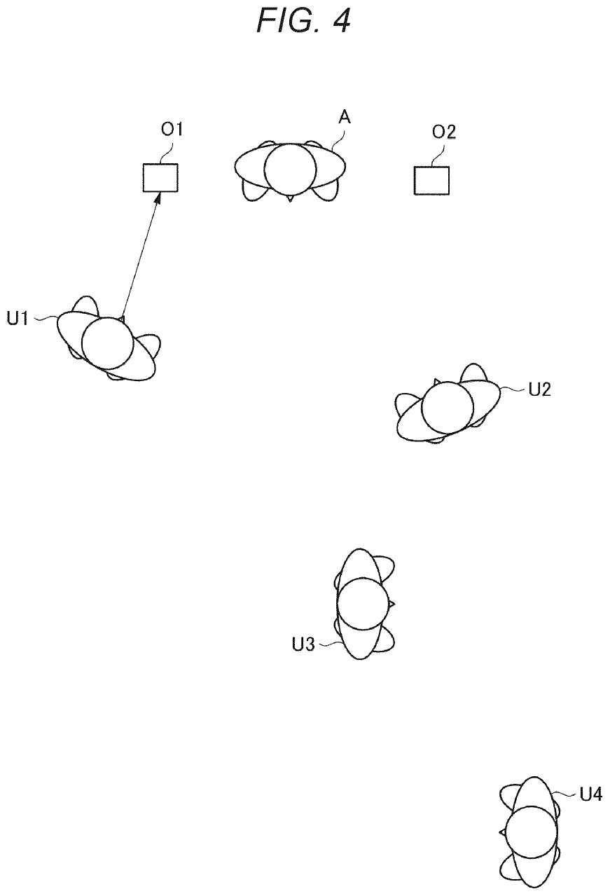

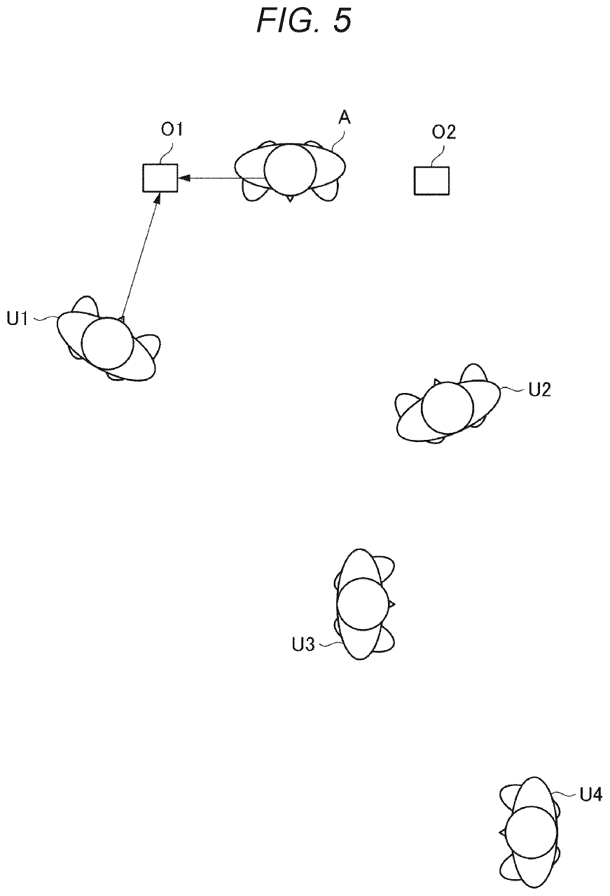

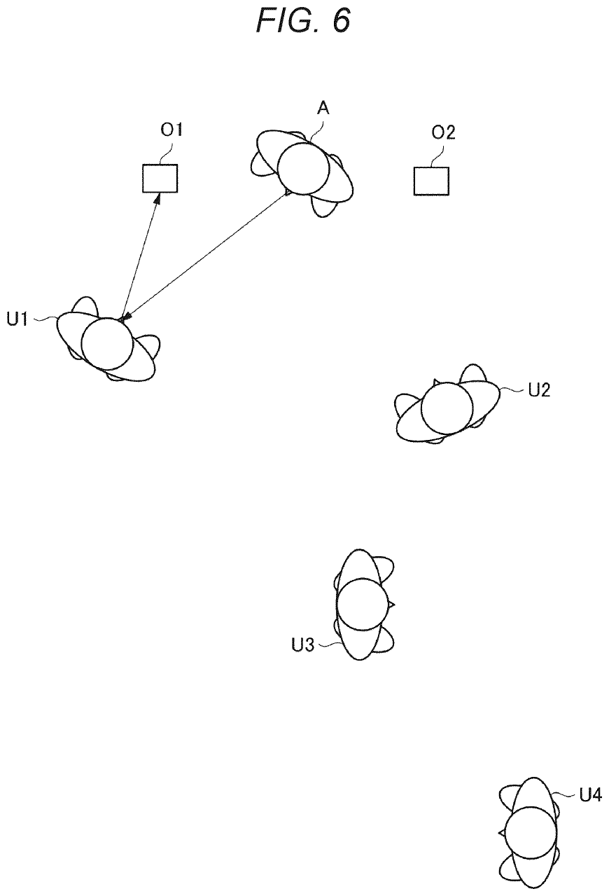

FIG. 4, FIG. 5, and FIG. 6 are explanatory diagrams for describing an example of motion control for the avatar A according to a second embodiment. FIG. 4 illustrates an example of a virtual space in which the avatar A, a virtual object O1, a virtual object O2, and the avatars corresponding to a plurality of users are disposed.

For example, as illustrated in FIG. 4, the user U1 visually recognizes the virtual object O1 disposed next to the avatar A. At this time, the user U2, the user U3, and the user U4 do not visually recognize the avatar A, the virtual object O1, and the virtual object O2.

In this case, as illustrated in FIG. 5, the control unit 160 may control the operation of directing the line-of-sight of the avatar A to the virtual object O1 visually recognized by the user U1.

Thereafter, as illustrated in FIG. 6, the control unit 160 may control the operation of directing the line-of-sight of the avatar A to the user U1 who visually recognizes the virtual object O1.

Thus, the control unit 160 can guide the line-of-sight of the user U1 with joint attention toward the avatar A, and the eye contact between the user U1 and the avatar A can be easily established.

Note that in a case where a plurality of users visually recognizes a plurality of virtual objects, the control unit 160 may control the operation of directing the line-of-sight of the avatar A to the virtual object visually recognized by the user for a longer time.

For example, the user U1 visually recognizes the virtual object O1, and the user U2 visually recognizes the virtual object O2. Then, in a case where the time during which the user U1 visually recognizes the virtual object O1 is longer than the time during which the user U2 visually recognizes the virtual object O2, the control unit 160 may control the operation of directing the line-of-sight of the avatar A to the virtual object O1.

Thereafter, as described above, the control unit 160 may control the operation of directing the line-of-sight of the avatar A to the user U1 who visually recognizes the virtual object O1. Then, in a case where the eye contact between the user U1 and the avatar A is not established, the control unit 160 may control the operation of directing the line-of-sight of the avatar A to the virtual object O2 that has been visually recognized for the next long time.

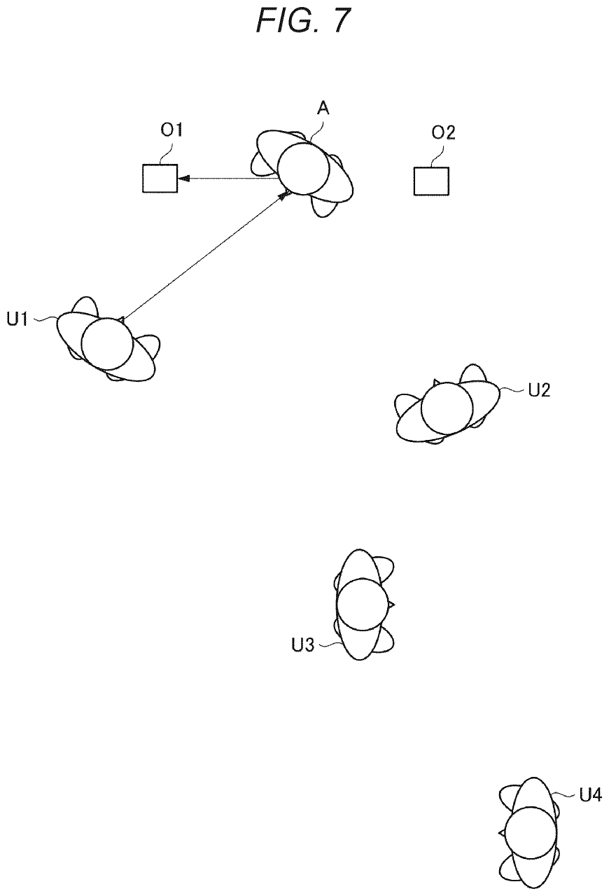

FIG. 7 is an explanatory diagram for describing another example of the motion control for the avatar A according to the second embodiment. In FIG. 7, a case where the user U1 visually recognizes the avatar A will be described.

First, in a case where the user U1 visually recognizes the avatar A, the control unit 160 controls the operation of directing the line-of-sight of the avatar A to the user U1.

Thereafter, as illustrated in FIG. 7, the control unit 160 may control the operation of directing the line-of-sight of the avatar A toward the virtual object O1. For example, in a case where the eye contact is established between the avatar A and the user U1, the control unit 160 may control the operation of directing the line-of-sight of the avatar A to the virtual object O1 around the avatar A.

In the second embodiment described above, the control unit 160 can induce gaze guidance for guiding the line-of-sight of the user toward a direction in which the virtual object is present. For example, in a case where the virtual object is information including information desired to be visually recognized by the user, the user can visually recognize the information more easily.

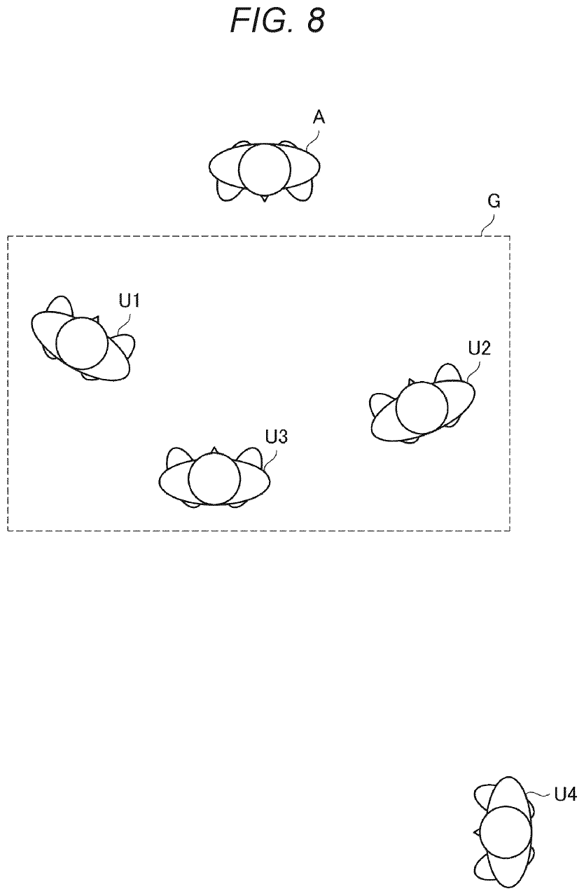

A specific example of the motion control for the avatar A according to the second embodiment of the present disclosure has been described above. Next, a specific example of the motion control for the avatar A according to a third embodiment will be described with reference to FIG. 8.

### 2.4. Third Embodiment

FIG. 8 is an explanatory diagram for describing the specific example of the motion control for the avatar A according to the third embodiment. The estimation unit 150 according to the present disclosure may estimate a group G indicating a group moving in the same or similar direction or at the same or similar speed on the basis of the motion information regarding a plurality of users.

For example, the estimation unit 150 may estimate a plurality of the users moving in the same or similar direction as one group G. Furthermore, the estimation unit 150 may estimate a plurality of the users moving in the same or similar direction as one group G.

For example, when the user U1, the user U2, and the user U3, which are illustrated in FIG. 8, moves in the same or similar direction or at the same or similar speed, the estimation unit 150 may estimate the user U1, the user U2, and the user U3 as one group.

Then, the control unit 160 may perform control to sequentially direct the line-of-sight of the avatar A. For example, the control unit 160 may control the operation of equally directing the line-of-sight of the avatar A to the user U1, the user U2, and the user U3, which are included in the group G illustrated in FIG. 8.

Furthermore, the estimation unit 150 may estimate a user having the largest movement among the users included in the group. The control unit 160 may control the operation of directing the line-of-sight of the avatar A to a user having the largest movement among a plurality of the users included in the group G.

Furthermore, in a case where the eye contact between the user having the largest movement and the avatar A is not established, the control unit 160 may control the operation of directing the line-of-sight of the avatar A to a user having the next largest movement.

According to the third embodiment described above, the control unit 160 can improve the possibility of establishing the eye contact with the user included in the group by directing the line-of-sight of the avatar to the user included in the same group, and can achieve smooth communication.

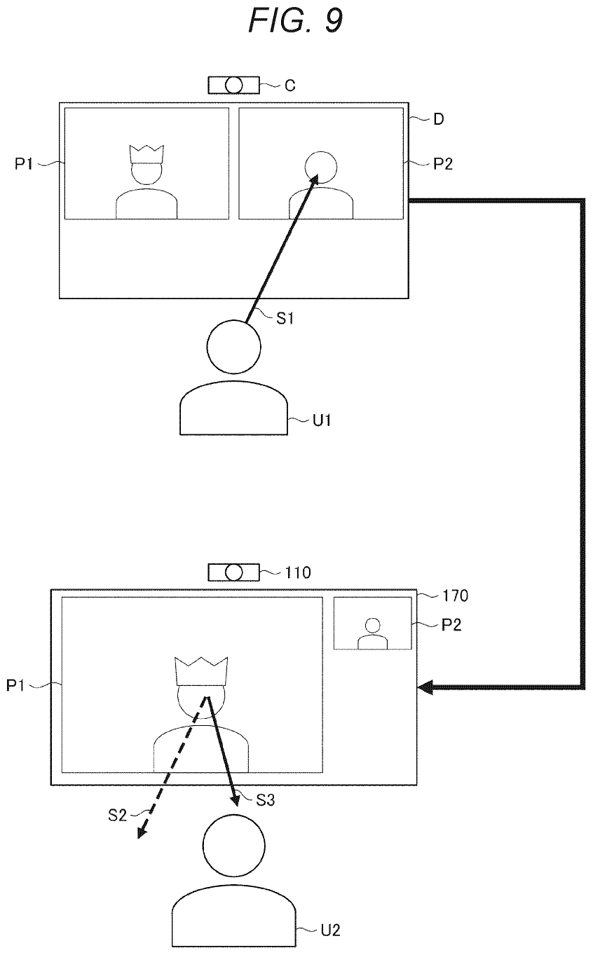

The specific example of the motion control for the avatar A according to the third embodiment has been described above. In the first to third embodiments, the specific example of the motion control for the avatar A in the virtual space has been mainly described, but the motion control for the avatar A according to the present disclosure is not limited to such an example. For example, the motion control for the avatar A according to the present disclosure is also applicable to digital out of home (DOOH) as illustrated in FIG. 1. In this case, the user is not the avatar in the virtual space, but the actual user. Next, a specific example of the motion control for the avatar A according to a fourth embodiment will be described with reference to FIG. 9.

### 2.5. Fourth Embodiment

FIG. 9 is an explanatory diagram for describing a specific example of the motion control for the avatar A according to the fourth embodiment. In FIG. 9, a case where a salesclerk U1 remotely serves a customer U2 will be described. In the following description, a terminal on the customer U2 side will be described as the information processing device 10 according to the present disclosure, and a terminal on the salesclerk U1 side will be described as a terminal other than the information processing device 10. However, both the terminal of the clerk U1 and the terminal of the customer U2 may be the information processing devices 10.

First, a display D of the terminal on the salesclerk U1 side may display an image P1 including the salesclerk U1 obtained by a camera C and an image P2 including the customer U2 obtained by the camera 110 included in the information processing device 10 on the customer U2 side.

Furthermore, the display unit 170 included in the information processing device 10 on the customer U2 side may display the image P1 including the salesclerk U1 obtained by the camera C included in the terminal on the salesclerk U1 side and the image P2 including the customer U2 obtained by the camera 110.

Furthermore, the image P1 can include a product displayed in the background of the salesclerk U1 and information related to the product. Furthermore, an avatar image as illustrated in FIG. 9 may be superimposed on the salesclerk U1 included in the image P1. For example, the avatar image may be displayed by being superimposed on the entire body and the face of the salesclerk U1, or a part of the face (for example, a mask or the like covering the periphery of the eyes) of the salesclerk U1.

For example, the control unit 160 may control the motion of the avatar by imitating the motion of the salesclerk U1 at the normal time.

Then, in a case where the camera C detects that the line-of-sight of the salesclerk U1 is directed in a direction S1 in which the face of the customer U2 is present, the terminal of the salesclerk U1 may transmit information including a fact that the salesclerk U1 visually recognizes the customer U2 to the information processing device 10 of the customer U2.

The information processing device 10 of the customer U2 may control the motion of the avatar superimposed on the image including the salesclerk U1 on the basis of the information received from the terminal of the salesclerk U1.

Here, in a case where the motion of the avatar is controlled by imitating the motion of the salesclerk U1, in the display unit 170 included in the information processing device 10 of the customer U2, the control unit 160 causes the line-of-sight of the avatar to be directed in a direction S2 corresponding to the direction S1 with reference to the camera C.

In this case, it is difficult for the customer U2 to recognize whether or not the salesclerk U1 is visually recognizing the customer U2.

Thus, the control unit 160 according to the present disclosure may control the operation of directing the line-of-sight of the avatar to the customer U2 when information including a fact that the salesclerk U1 visually recognizes the customer U2 is acquired. Therefore, since the line-of-sight of the avatar is directed in a direction S3 in which the customer U2 is present, the customer U2 can more easily recognize whether or not the salesclerk U1 visually recognizes the customer U2.

Moreover, in a case where the eye contact between the avatar and the customer U2 to which the line-of-sight of the avatar is directed is established, the control unit 160 may control a predetermined motion of the avatar. For example, the control unit 160 may control the operation related to the interaction to explain the product to the customer U2.

Note that the display D included in the terminal of the salesclerk U1 and the display unit 170 included in the information processing device 10 of the customer U2 may be different or the same as illustrated in FIG. 9 in sizes and positions at which the image P1 and the image P2 are displayed.

Furthermore, the example in which the avatar image is superimposed on the salesclerk U1 has been described, but the avatar image may be similarly superimposed on the customer U2.

Furthermore, the remote motion control for the avatar is not limited to the application to the customer service. For example, the remote motion control for the avatar is also applicable to remote live.

For example, the detection unit 130 included in the information processing device 10 of a remote live viewer detects the direction of a viewer's line-of-sight or viewer's face direction. Subsequently, the estimation unit 150 may estimate a virtual object visually recognized by the viewer.

Then, when the virtual object estimated by the estimation unit 150 is an avatar of a performer, the control unit 160 may control the operation of directing the line-of-sight of the avatar of the performer to the viewer.

At this time, the detection unit 130 may further detect the direction of the face of the performer's avatar. Then, when the viewer is present within a predetermined range from the direction of the performer's face, the control unit 160 may control the operation of directing the line-of-sight of the avatar of the performer to the viewer.

Note that in a case where the avatar is far away, it may be difficult for the viewer to recognize whether the avatar visually recognizes the viewer only with the movement of the line-of-sight of the avatar. Thus, for example, the control unit 160 may dynamically change a ratio between the movement of the line-of-sight of the avatar and the movement of the avatar's face.

Furthermore, the control unit 160 may control a predetermined motion of the avatar when the viewer to which the line-of-sight is directed performs a motion such as waving a hand. The predetermined motion here may include, for example, a motion of tilting a neck to the left and right according to the motion of the hand, nodding, shaking the hand, or winking an eye.

Thus, the viewer who has participated in the remote live can feel more realistic and immersive in participating in the actual live show.

Furthermore, the control unit 160 included in the information processing device 10 on a distributor side may control the operation of directing the line-of-sight of the avatar to the viewer. In this case, the communication unit 190 may transmit motion information for directing the line-of-sight of the avatar to the information processing device 10 on the viewer side.

The details of control of the information processing device 10 according to the present disclosure has been described above. Next, a specific example of the operation processing of the information processing device 10 according to the present disclosure will be described.

### 3. Example of Operation Processing

### 3.1. Entire Flow

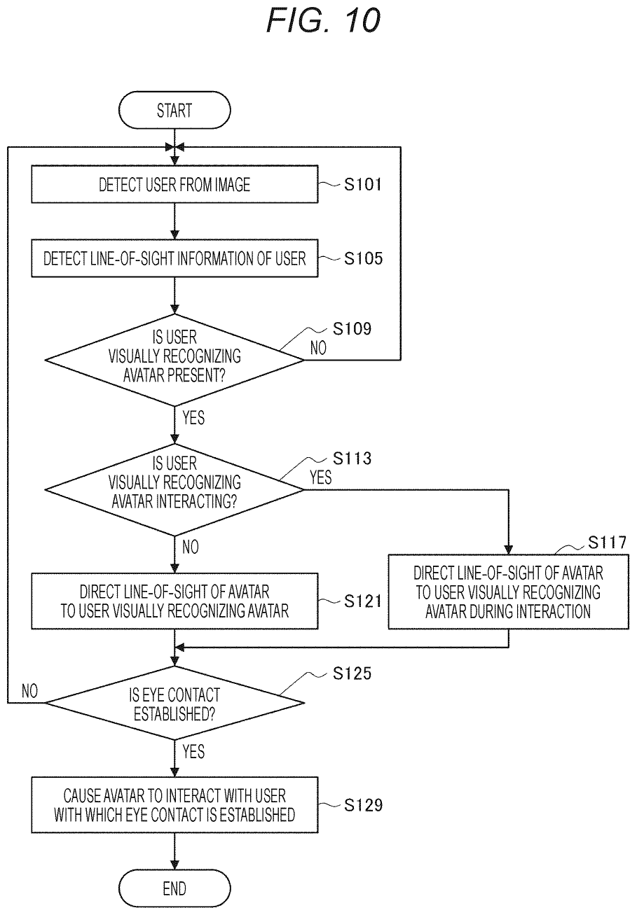

FIG. 10 is an explanatory diagram for describing an example of an entire flow of operation processing of the information processing device 10 according to the present disclosure. First, the detection unit 130 detects the user from the image acquired by the camera 110 (S101).

Subsequently, the detection unit 130 detects line-of-sight information of the user (S105).

Then, the estimation unit 150 estimates an object visually recognized by the user from the line-of-sight information of the user, and determines whether or not a user who visually recognizes the avatar is present (S109). In a case where it is determined that a user visually recognizing the avatar is present (S109/Yes), the processing proceeds to S113. In a case where it is determined that the user visually recognizing the avatar is not present (S109/No), the processing returns to S101 again.

In a case where it is determined that the user visually recognizing the avatar is present (S109/Yes), the control unit 160 determines whether or not the user visually recognizing the avatar is interacting (S113). In a case where the interaction is being performed (S113/Yes), the processing proceeds to S117, and in a case where the interaction is not being performed (S113/No), the processing proceeds to S121.

In a case where the interaction is being performed (S113/Yes), the control unit 160 controls the operation of directing the line-of-sight of the avatar to the user visually recognizing the avatar during the interaction (S117).

In a case where the interaction is not performed (S113/No), the control unit 160 controls the operation of directing the line-of-sight of the avatar to the user visually recognizing the avatar (S121).

Then, the control unit 160 determines whether or not the eye contact is established between the avatar and the user (S125). In a case where it is determined that the eye contact is established (S125/Yes), the processing proceeds to S129, and in a case where it is determined that the eye contact is not established (S125/No), the processing returns to S101 again.

In a case where it is determined that the eye contact is established (S125/Yes), the control unit 160 controls the operation of causing the avatar to interact with the user with who the eye contact is established (S129), and the control unit 160 according to the present disclosure ends the processing.

The example of an entire flow of the operation processing of an information processing device 10 according to the present disclosure has been described above. Next, in S121 of FIG. 10, an example of a flow of the operation processing of directing the line-of-sight of the avatar controlled by the control unit 160 will be described.

### 3.2. Flow According to Operation Processing of Directing Line-of-Sight

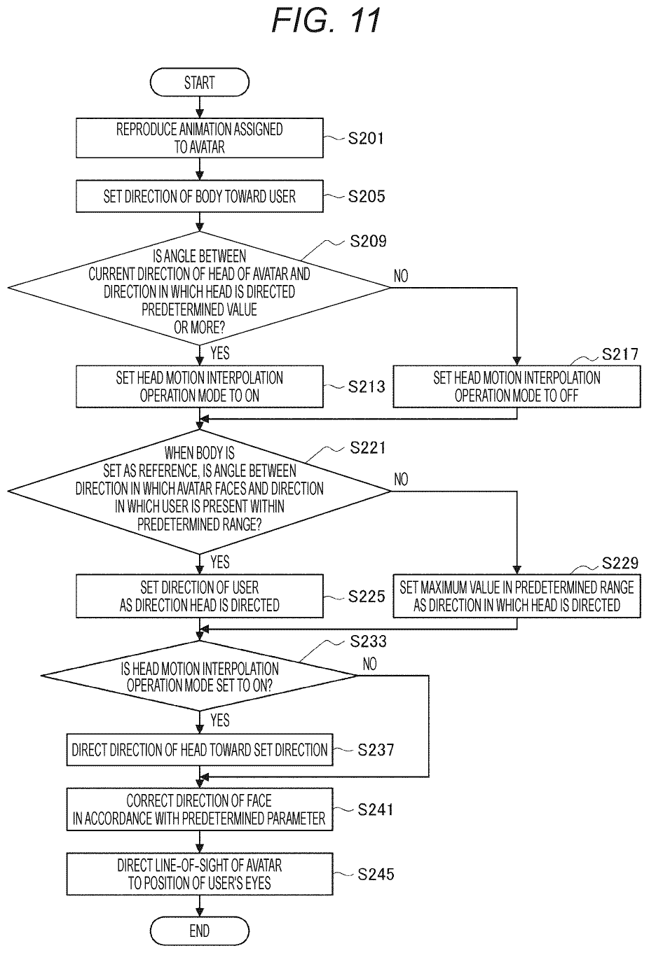

FIG. 11 is an explanatory diagram for describing the operation processing of directing the line-of-sight according to the present disclosure. First, the control unit 160 reproduces the animation assigned to the avatar (S201).

Subsequently, the control unit 160 sets the direction of the avatar's body toward the user using IK (S205).

Then, the control unit 160 determines whether or not an angle between the current direction in which the head of the avatar is directed and a direction in which the head is directed is a predetermined value or more (S209). At this time, the direction in which the head is directed may be, for example, a half direction from the direction in which the current avatar's head is directed to the direction in which the user is present. In a case where the angle is a predetermined value or more (S209/Yes), the processing proceeds to S213, and in a case where the angle is less than a predetermined value (S209/No), the processing proceeds to S217.

In a case where the angle is equal to or greater than a predetermined value (S209/Yes), the control unit 160 sets the head motion interpolation operation mode to ON (S213).

In a case where the angle is less than a predetermined value (S209/No), the head motion interpolation operation mode is set to OFF (S217).

Then, when the body of the avatar is set as a reference, the control unit 160 determines whether or not the angle between the direction in which the avatar's head faces and the direction in which the user is present is within a predetermined range (S221). In a case where the angle is within a predetermined range (S221/Yes), the processing proceeds to S225, and in a case where the angle is out of a predetermined range (S221/No), the processing proceeds to S229.

In a case where the angle is within a predetermined range (S221/Yes), the control unit 160 sets the direction in which the user is present as a direction in which the avatar's head is directed (S225).

In a case where the angle is out of a predetermined range (S221/No), the control unit 160 sets the maximum value in the predetermined range as a direction in which the avatar's head is directed (S229).

Then, the control unit 160 determines whether or not the head motion interpolation operation mode is set to ON (S233). In a case where the head motion interpolation operation mode is set to ON (S233/Yes), the processing proceeds to S237, and in a case where the head motion interpolation operation mode is set to OFF (S233/No), the processing proceeds to S241.

In a case where the head motion interpolation operation mode is set to ON (S233/Yes), the control unit 160 performs control to direct the avatar's head toward the direction set in S225 or S229 (S237).

Then, the control unit 160 corrects the direction of the face in accordance with various predetermined parameters (for example, the movable range in the direction of the avatar's head, and the like) determined on the basis of the characteristics and characterization of the avatar (S241).

Then, the control unit 160 controls the operation of directing the line-of-sight of the avatar to the position of the user's eyes (S245), and the control unit 160 according to the present disclosure ends the processing. Note that, in controlling the operation of directing the line-of-sight of the avatar, the control unit 160 may control the motion of the left and right eyes of the avatar to fall within the movable range.

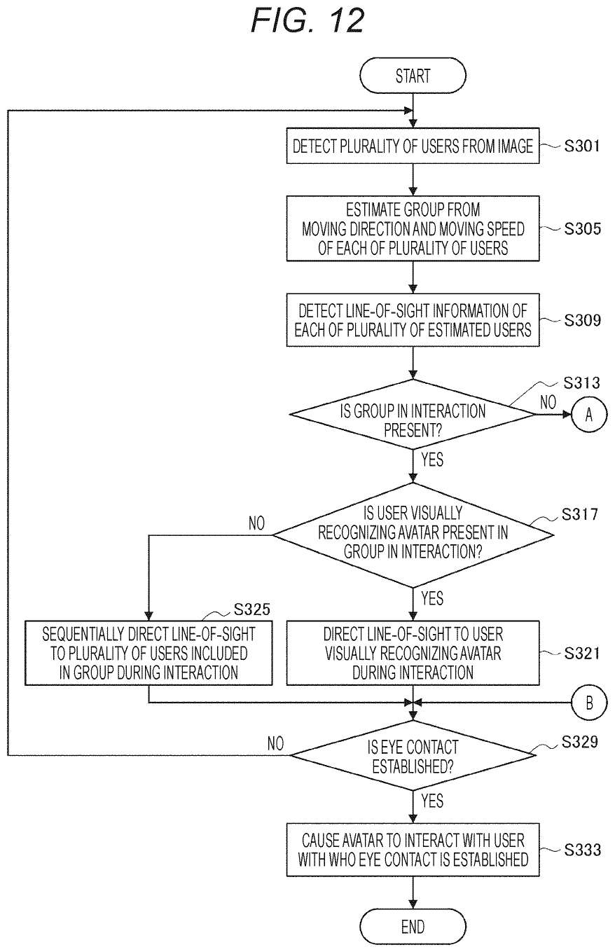

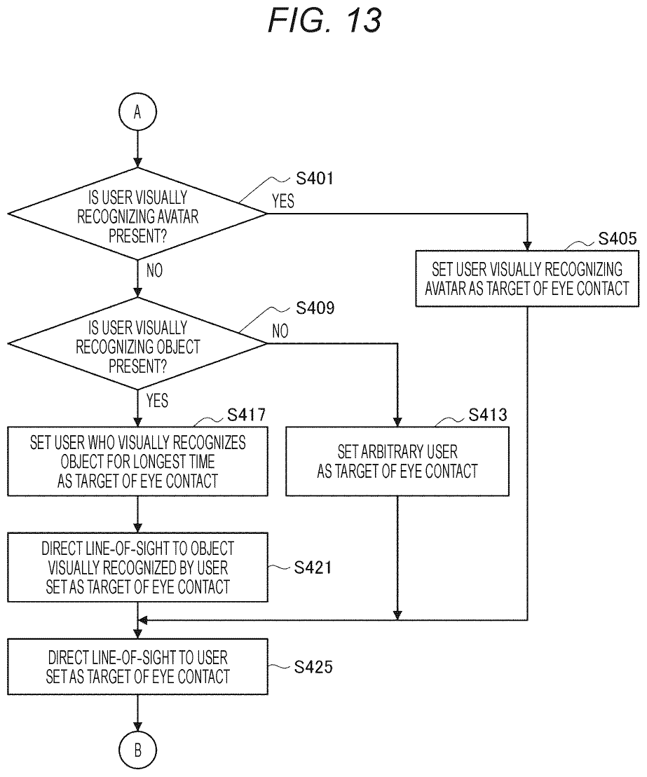

The example of the operation processing of directing the line-of-sight of the avatar controlled by the control unit 160 according to the present disclosure has been described above. Next, a specific example of operation processing when a plurality of users is present will be described with reference to FIGS. 12 and 13.

### 3.3. Flow According to Operation Processing When Plurality of Users is Present

FIGS. 12 and 13 are explanatory diagram for describing an example of operation processing when a plurality of user is present. First, the detection unit 130 detects the user from the image acquired by the camera 110 (S301).

Next, the estimation unit 150 estimates a group from the moving direction and the moving speed of each of a plurality of the users (S305).

Then, the detection unit 130 detects line-of-sight information of each of a plurality of the users estimated as a group (S309).

Then, the control unit 160 determines whether or not there is an interacting group (S313). In a case where it is determined that there is a group in interaction (S313/Yes), the processing proceeds to S317, and in a case where it is determined that there is no group in interaction (S313/No), the processing proceeds to S401 to be illustrated in FIG. 13. Note that a case where it is determined that there is no group in interaction (S313/No) will be described later.

In a case where it is determined that there is a group in interaction (S313/Yes), the estimation unit 150 estimates an object visually recognized by the user from the line-of-sight information of the user, and determines whether or not a user who visually recognizes the avatar is present in the group in interaction (S317). In a case where it is determined that the user visually recognizing the avatar is present (S317/Yes), the processing proceeds to S321, and in a case where it is determined that the user visually recognizing the avatar is not present (S317/No), the processing returns to S325.

In a case where it is determined that the user visually recognizing the avatar is present (S317/Yes), the control unit 160 controls the operation of directing the line-of-sight of the avatar to the user visually recognizing the avatar during the interaction (S321).

In a case where it is determined that the user visually recognizing the avatar is not present (S317/No), the control unit 160 controls the operation of sequentially directing the line-of-sight of the avatar to a plurality of the users included in the group during the interaction (S325).

Then, the control unit 160 determines whether or not the eye contact is established between the avatar and the user to which the line-of-sight of the avatar is directed (S329). In a case where it is determined that the eye contact is established (S329/Yes), the processing proceeds to S333, and in a case where it is determined that the eye contact is not established (S329/No), the processing returns to S301 again.

In a case where the eye contact is established (S329/Yes), the control unit 160 controls the operation of causing the avatar to interact with the user with who the eye contact is established (S333), and the control unit 160 according to the present disclosure ends the processing.

Next, a case where it is determined that there is no group in interaction (S313/No) will be described with reference to FIG. 13.

In a case where it is determined that there is no group in interaction (S313/No), the estimation unit 150 estimates an object visually recognized by a plurality of users from the line-of-sight information of the plurality of users, and determines whether or not a user visually recognizing the avatar is present (S401). In a case where it is determined that the user visually recognizing the avatar is present (S401/Yes), the processing proceeds to S405, and in a case where it is determined that the user visually recognizing the avatar is not present (S401/No), the processing returns to S409.

In a case where it is determined that the user visually recognizing the avatar is present (S401/Yes), the control unit 160 sets the user visually recognizing the avatar as a target of the eye contact (S405).

In a case where it is determined that the user visually recognizing the avatar is not present (S401/No), the control unit 160 determines whether or not the user visually recognizing an object other than the avatar is present (S409). In a case where it is determined that the user visually recognizing the object is not present (S409/No), the processing proceeds to S413, and in a case where it is determined that the user visually recognizing the object is present (S409/Yes), the processing proceeds to S417.

In a case where it is determined that the user visually recognizing the object is not present (S409/No), the control unit 160 sets an arbitrary user as a target of the eye contact (S413).

In a case where it is determined that the user visually recognizing the object is present (S409/Yes), the control unit 160 sets the user who visually recognizes the object for the longest time as a target of the eye contact (S417).

Then, the control unit 160 controls the operation of directing the line-of-sight of the avatar to the object visually recognized by the user set as the target of the eye contact (S421).

Then, the control unit 160 controls the operation of directing the line-of-sight of the avatar to the user set as the target of the eye contact (S425), and the processing proceeds to S329 illustrated in FIG. 12.

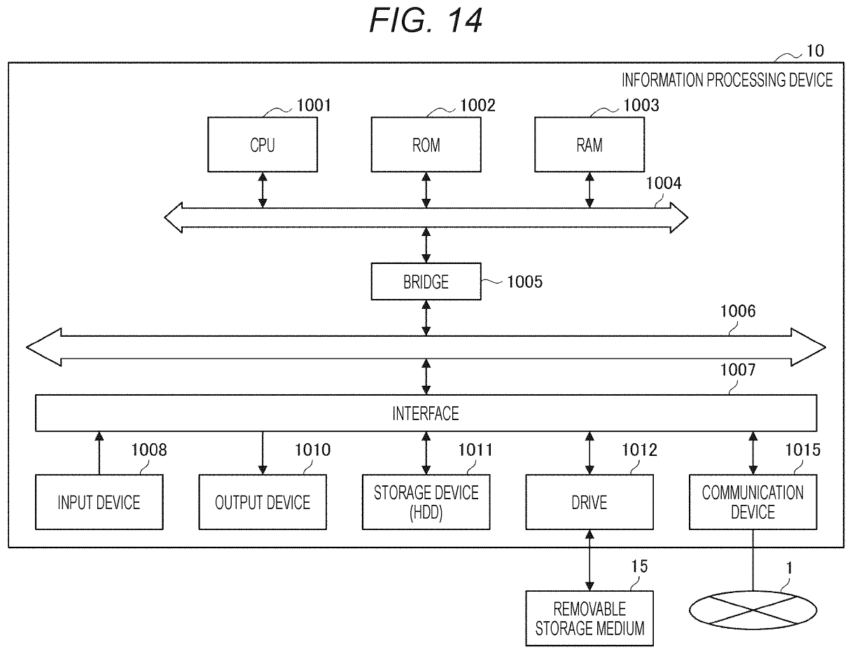

The specific example of the operation processing according to the present disclosure has been described above. Next, an example of a hardware configuration of the information processing device 10 according to the present disclosure will be described with reference to FIG. 14.

### 4. Hardware Configuration Example

The embodiments of the present disclosure have been described above. Each information processing described above is implemented by cooperation of software and hardware of the information processing device 10 to be described below.

FIG. 14 is a block diagram illustrating a hardware configuration of the information processing device 10 according to the present disclosure. The information processing device 10 includes a central processing unit (CPU) 1001, a read only memory (ROM) 1002, a random access memory (RAM) 1003, and a host bus 1004. Furthermore, the information processing device 10 includes a bridge 1005, an external bus 1006, an interface 1007, an input device 1008, an output device 1010, a storage device (HDD) 1011, a drive 1012, and a communication device 1015.

The CPU 1001 functions as an arithmetic processing device and a control device, and controls the overall operation in the information processing device 10 in accordance with various programs. Furthermore, the CPU 1001 may be a microprocessor. The ROM 1002 stores, for example, programs and operation parameters that are used by the CPU 1001. The RAM 1003 temporarily stores, for example, the programs used during execution of the CPU 1001, and parameters that change as appropriate during the execution. The CPU 1001, the ROM 1002, and the RAM 1003 are connected to each other by the host bus 1004 including a CPU bus. Functions of the estimation unit 150, the control unit 160, and the like described with reference to FIG. 2 can be achieved by cooperation of the CPU 1001, the ROM 1002, the RAM 1003, and the software.

The host bus 1004 is connected to the external bus 1006 such as a peripheral component interconnect/interface (PCI) bus via the bridge 1005. Note that the host bus 1004, the bridge 1005, and the external bus 1006 are not necessarily configured separately, and functions thereof may be implemented on one bus.

The input device 1008 includes an input unit for allowing a user to input information, such as a mouse, a keyboard, a touch panel, a button, a microphone, a switch, and a lever, and an input control circuit that generates an input signal on the basis of an input by the user, and outputs the input signal to the CPU 1001. By operating the input device 1008, the user of the information processing device 10 can input various data into the information processing device 10, or instruct the information processing device 10 to perform processing operation.

For example, the output device 1010 includes a display device such as a liquid crystal display device, an OLED device, or a lamp. Moreover, the output device 1010 includes an audio output device such as a speaker or headphones. The output device 1010 outputs, for example, a reproduced content. Specifically, the display device displays various kinds of information such as reproduced image data with text or images. On the other hand, the audio output device converts the reproduced audio data and the like into audio and outputs the audio.

The storage device 1011 is a device for storing data. The storage device 1011 may include a storage medium, a recording device that records data in the storage medium, a reading device that reads data from the storage medium, and a deletion device that deletes data recorded on the storage medium. For example, the storage device 1011 includes a hard disk drive (HDD). The storage device 1011 drives a hard disk and stores programs to be executed by the CPU 1001 and various data.

The drive 1012 is a reader-writer for a storage medium, and is built in or externally attached to the information processing device 10. The drive 1012 reads information recorded in a removable storage medium 15 mounted thereon, such as a magnetic disc, an optical disc, a magneto-optical disc, or a semiconductor memory, and outputs the information to the RAM 1003. Furthermore, the drive 1012 can also write information to the removable storage medium 15.

The communication device 1015 is, for example, a communication interface including a communication device or the like for connection to a network. Furthermore, the communication device 1015 may be a wireless LAN compatible communication device, a long term evolution (LTE) compatible communication device, or a wire communication device that performs wired communication.

### 5. Supplement Notes

The preferred embodiments of the present disclosure have been described in detail above with reference to the accompanying drawings, but the present disclosure is not limited to such examples. It is apparent that a person having ordinary knowledge in the technical field to which the present disclosure belongs can devise various change examples or modification examples within the scope of the technical idea described in the claims, and it will be naturally understood that such examples also belong to the technical scope of the present disclosure.

For example, when it is difficult to establish the eye contact between the user and the avatar, the control unit 160 may control the operation of making the eye contact easier prior to the operation of directing the line-of-sight. Examples of the motion for making the eye contact easier include a motion of approaching the user, a motion for matching the viewpoint of the avatar with the height of the user, and a motion of the avatar standing up.

Furthermore, in a case where a plurality of the users visually recognizes the avatar, the control unit 160 may control the operation of directing the line-of-sight of the avatar to a rear-side user while avoiding a front-side user. Thus, the rear-side user can visually recognize the avatar easily, and the eye contact can be more easily established.

Furthermore, in a case where the user is squinting, for example, it is determined that the user is in a state in which it is difficult for the user to visually recognize the avatar due to reflection of light, and the control unit 160 may control the operation of changing the standing position of the avatar.

Furthermore, the control unit 160 may change the motion of the avatar according to various environmental conditions such as a time zone, a day of the week, or a holiday. For example, in a case where the eye contact between the user and the avatar is established in the morning, the control unit 160 may cause the avatar to first utter a word “Good morning”.

Furthermore, in the above-described example, the example in which the control unit 160 controls the motion of the avatar has been mainly described, but the control target according to the present disclosure is not limited to the avatar. For example, the control target according to the present disclosure may be a mobile body such as a robot. In this case, the control unit 160 may direct the line-of-sight of the robot to the user when the user visually recognizes the robot. Moreover, in a case where the eye contact is established between the user and the robot, the control unit 160 may perform control to move the robot close to the user.

Furthermore, the avatar according to the present disclosure may be an avatar without eyes (for example, plants and the like). In this case, the control unit 160 may perform control to direct the direction of the avatar's face and the direction of the body of the avatar to the user when the user visually recognizes the avatar.

Furthermore, the information processing device 10 according to the present disclosure may not include all the configurations illustrated in FIG. 2. For example, in a case where the information processing device 10 is a server, the communication unit 190 may transmit information related to the motion of the avatar controlled by the control unit 160 to the display device. In this case, the information processing device 10 according to the present disclosure may not include the display unit 170 and the voice presentation unit 180.

Furthermore, another device such as a display device may include the camera 110 and the microphone 120. In this case, the information processing device 10 according to the present disclosure may not include the camera 110 and the microphone 120.

Furthermore, each step in the processing of the information processing system of the present description is not necessarily processed in time series in the order described as the flowchart. For example, each step in the processing of the information processing system may be processed in an order different from the order described as the flowchart or in parallel.

Furthermore, it is also possible to create a computer program for causing hardware built in the information processing device 10, such as a CPU, a ROM, and a RAM, to exhibit a function equivalent to each configuration of the above-described information processing device 10. Furthermore, a non-transitory storage medium storing the computer program is also provided.

Furthermore, the effects described in the present specification are merely exemplary or illustrative, and are not restrictive. That is, the technology according to the present disclosure may exert other effects apparent to those skilled in the art from the description of the present specification in addition to or instead of the effects described above.

Note that the following configurations also fall within the technological scope of the present disclosure.
(1)

An information processing device including:
an acquisition unit configured to acquire line-of-sight information indicating a direction of a line-of-sight of a user;
an estimation unit configured to estimate an object visually recognized by the user on the basis of the line-of-sight information; and
a control unit configured to control a motion of a target on the basis of the object visually recognized by the user.
(2)

The information processing device according to (1), in which
the target includes an avatar, and
the control unit
controls operation of directing the line-of-sight of the avatar to the user on the basis of the object visually recognized by the user.
(3)

The information processing device according to (2), in which
the control unit
controls, with respect to the object visually recognized by the user, operation of directing the line-of-sight of the avatar to the object, and further controls the operation of directing the line-of-sight of the avatar to the user.
(4)

The information processing device according to (2) or (3), in which
the control unit
controls a predetermined motion of the avatar when the line-of-sight of the user to which the line-of-sight of the avatar is directed and the line-of-sight of the avatar match for a predetermined time or more.
(5)

The information processing device according to (3) or (4), in which
the acquisition unit
acquires motion information indicating a motion of the user, and
the control unit
controls a predetermined motion of the avatar when specific motion information of the user to which the line-of-sight of the avatar is directed is acquired.
(6)

The information processing device according to (5), in which
the predetermined motion includes operation of directing the line-of-sight of the avatar to an object around the avatar.
(7)

The information processing device according to (5) or (6), in which
the acquisition unit
acquires voice information indicating words uttered by the user, and
the control unit
controls the motion of the avatar on the basis of the voice information.
(8)

The information processing device according to (6) or (7), in which
the user indicates a plurality of users, and
the control unit
performs control to sequentially direct the line-of-sight of the avatar to each of the plurality of users when the line-of-sight information of any one of the plurality of users is not acquired.
(9)

The information processing device according to any one of (6) to (8), in which
the object includes a virtual object.
(10)

The information processing device according to (9), in which
the virtual object includes the avatar, and
the control unit
performs control to direct the line-of-sight of the avatar to the user when the user visually recognizes the avatar.
(11)

The information processing device according to (10), in which
the control unit
performs control to direct the line-of-sight of the avatar to the user when the user visually recognizes the avatar and further, the user does not interact with another user.
(12)

The information processing device according to any one of (5) to (11), in which
the estimation unit
estimates a group indicating a group moving in the same or similar direction or at the same or similar speed on the basis of the motion information acquired by the acquisition unit, and
the control unit
performs control to sequentially direct the line-of-sight of the avatar to each of the users included in the group.
(13)

The information processing device according to (12), in which
the estimation unit
estimates a user having the largest motion among the users included in the group, and
the control unit
performs control to direct the line-of-sight of the avatar to the user having the largest motion among the plurality of users included in the group.
(14)

The information processing device according to any one of (2) to (13), in which
the control unit
controls a direction of a head of the avatar on the basis of a direction in which the head of the avatar faces and a direction in which the user is present.
(15)

The information processing device according to (14), in which
the control unit
performs control to move the head of the avatar toward the direction in which the user is present when an angle between the direction in which the head of the avatar faces and the direction in which the user is present is a predetermined value or more.
(16)

The information processing device according to (15), in which
the control unit
moves the head of the avatar toward the direction in which the user is present, and further performs control to direct the line-of-sight of the avatar to the user when the angle is the predetermined value or more.
(17)

The information processing device according to (16), in which
the predetermined value is determined on the basis of characteristics set for the avatar.
(18)

The information processing device according to (17), in which
the control unit
performs control to move the head of the avatar toward the direction in which the user is present at a speed corresponding to at least one of a magnitude of a motion of the user or a magnitude of the angle.
(19)

An information processing method executed by a computer, the method including:
acquiring line-of-sight information indicating a direction of a line-of-sight of a user;
estimating an object visually recognized by the user on the basis of the line-of-sight information; and
controlling a motion of a target on the basis of the object visually recognized by the user.
(20)

A non-transitory computer-readable storage medium storing a program for causing a computer to execute:
an acquisition function of acquiring line-of-sight information indicating a direction of a line-of-sight of a user;
an estimation function of estimating an object visually recognized by the user on the basis of the line-of-sight information; and
a control function of controlling a motion of a target on the basis of the object visually recognized by the user.

### Reference Signs List

10 Information processing device
110 Camera
120 Microphone
130 Detection unit
140 Voice recognition unit
150 Estimation unit
160 Control unit
170 Display unit
180 Voice presentation unit
190 Communication unit

1. An information processing device comprising:
an acquisition unit configured to acquire line-of-sight information indicating a direction of a line-of-sight of a user;
an estimation unit configured to estimate an object visually recognized by the user on a basis of the line-of-sight information; and
a control unit configured to control a motion of a target on a basis of the object visually recognized by the user.

2. The information processing device according to claim 1, wherein
the target includes an avatar, and
the control unit
controls operation of directing the line-of-sight of the avatar to the user on a basis of the object visually recognized by the user.

3. The information processing device according to claim 2, wherein
the control unit
controls, with respect to the object visually recognized by the user, operation of directing the line-of-sight of the avatar to the object, and further controls the operation of directing the line-of-sight of the avatar to the user.

4. The information processing device according to claim 3, wherein
the control unit
controls a predetermined motion of the avatar when the line-of-sight of the user to which the line-of-sight of the avatar is directed and the line-of-sight of the avatar match for a predetermined time or more.

5. The information processing device according to claim 4, wherein
the acquisition unit
acquires motion information indicating a motion of the user, and
the control unit
controls a predetermined motion of the avatar when specific motion information of the user to which the line-of-sight of the avatar is directed is acquired.

6. The information processing device according to claim 5, wherein
the predetermined motion includes operation of directing the line-of-sight of the avatar to an object around the avatar.

7. The information processing device according to claim 6, wherein
the acquisition unit
acquires voice information indicating words uttered by the user, and
the control unit
controls the motion of the avatar on a basis of the voice information.

8. The information processing device according to claim 7, wherein
the user indicates a plurality of users, and
the control unit
performs control to sequentially direct the line-of-sight of the avatar to each of the plurality of users when the line-of-sight information of any one of the plurality of users is not acquired.

9. The information processing device according to claim 8, wherein
the object includes a virtual object.

10. The information processing device according to claim 9, wherein
the virtual object includes the avatar, and
the control unit
performs control to direct the line-of-sight of the avatar to the user when the user visually recognizes the avatar.

11. The information processing device according to claim 10, wherein
the control unit
performs control to direct the line-of-sight of the avatar to the user when the user visually recognizes the avatar and further, the user does not interact with another user.

12. The information processing device according to claim 11, wherein
the estimation unit
estimates a group indicating a group moving in a same or similar direction or at a same or similar speed on a basis of the motion information acquired by the acquisition unit, and
the control unit
performs control to sequentially direct the line-of-sight of the avatar to each of the users included in the group.

13. The information processing device according to claim 12, wherein
the estimation unit
estimates a user having a largest motion among the users included in the group, and
the control unit
performs control to direct the line-of-sight of the avatar to the user having the largest motion among the plurality of users included in the group.

14. The information processing device according to claim 13, wherein
the control unit
controls a direction of a head of the avatar on a basis of a direction in which the head of the avatar faces and a direction in which the user is present.

15. The information processing device according to claim 14, wherein
the control unit
performs control to move the head of the avatar toward the direction in which the user is present when an angle between the direction in which the head of the avatar faces and the direction in which the user is present is a predetermined value or more.

16. The information processing device according to claim 15, wherein
the control unit
moves the head of the avatar toward the direction in which the user is present, and further performs control to direct the line-of-sight of the avatar to the user when the angle is the predetermined value or more.

17. The information processing device according to claim 16, wherein
the predetermined value is determined on a basis of characteristics set for the avatar.

18. The information processing device according to claim 17, wherein
the control unit
performs control to move the head of the avatar toward the direction in which the user is present at a speed corresponding to at least one of a magnitude of a motion of the user or a magnitude of the angle.

19. An information processing method executed by a computer, the method comprising:
acquiring line-of-sight information indicating a direction of a line-of-sight of a user;
estimating an object visually recognized by the user on a basis of the line-of-sight information; and
controlling a motion of a target on a basis of the object visually recognized by the user.

20. A non-transitory computer-readable storage medium storing a program for causing a computer to execute:
an acquisition function of acquiring line-of-sight information indicating a direction of a line-of-sight of a user;
an estimation function of estimating an object visually recognized by the user on a basis of the line-of-sight information; and
a control function of controlling a motion of a target on a basis of the object visually recognized by the user.
